(19) United States
(12) Patent Application Publication
(10) Pub. No.: US 2025/0237106 A1
(43) Pub. Date: Jul. 24, 2025

(54) RAIN DEFLECTOR APPARATUS AND SYSTEM

(71) Applicant: STORM SHIELD OF MIAMI, INC., Miami Beach, FL (US)

(72) Inventors: Mark Fisher, Bal Harbour, FL (US); Todd Michael Glaser, Palm Beach, FL (US); Ronald Simkins, Miami, FL (US); David Kreps, Miami Beach, FL (US); Werner Blumenthal, Miami, FL (US)

(73) Assignee: STORM SHIELD OF MIAMI, INC., Miami Beach, FL (US)

(21) Appl. No.: 18/416,241

(22) Filed: Jan. 18, 2024

Related U.S. Application Data
(63) Continuation-in-part of application No. 17/994,231, filed on Nov. 25, 2022, now Pat. No. 12,312,859.
Application No. 17/994,231 is a continuation-in-part of application No. 17/428,113, filed on Aug. 3, 2021, now Pat. No. 12,234,684.

(51) Int. Cl. E06B 7/26; E06B 7/23

(52) U.S. Cl. CPC E06B 7/26; E06B 7/2316

(57) ABSTRACT

The disclosed invention pertains to a rain deflector apparatus designed to minimize water intrusion into sliding glass door tracks or similar structures. The deflector, with an innovative geometry, attaches securely to the door track, creating a sealing pressure against the floor and door. Its substantially flat sheet body incorporates a bottom seal portion and a top sealing surface, ensuring effective water diversion. The deflector can be part of a configurable system or a kit for customized assembly. The objectives include reducing water intrusion during severe weather, easy installation and removal, rigidity for shape maintenance, compliance for sealing force, and accessibility for regular door use. This rain deflector system presents a practical solution for varied structures, enhancing protection and user convenience.

### CROSS-REFERENCE TO RELATED APPLICATIONS

This application is a continuation in-part application of co-pending U.S. patent application Ser. No. 17/994,231, filed on Nov. 25, 2022, which is a continuation in-part of co-pending U.S. patent application Ser. No. 17/428,113, filed on Aug. 3, 2021, which was submitted under 35 U.S.C. 371 as a U.S. National Stage Entry of pending PCT/US21/12414, filed on Jan. 7, 2021, all of which are incorporated by reference herein in their entireties.

### FIELD OF THE INVENTION

The present invention generally relates to windstorm mitigation devices and, more specifically, to an improved apparatus and related system that includes a modular, compact, reusable device and related system which aids in the reduction of small debris and water intrusion through sliding glass door tracks during severe weather conditions.

### BACKGROUND OF THE INVENTION

In high rise condominiums, townhouses, apartment buildings, and private residences there are no current practical and/or efficient ways to reduce the amount of water intrusion through sliding glass doors, and their tracks, during severe weather. Hurricane rated or not, most sliding glass doors slide on tracks that are built with weep holes, which allow water that has accumulated to drain out—but this is not the case in conditions with wind-driven rain. Under these severe conditions, weep holes do not function properly as the storm-force winds actually push the rainwater inside, through the gaps between the sliding glass door and the track. Currently, there are no practical methods to reduce water intrusion under these conditions. Current offerings are difficult to install and/or are hard to store. Implementation and deployment of current methods is difficult.

It is a known issue with sliding glass doors that, due to the nature of their design to run in a track, water can accumulate within the track. Although sliding door tracks are generally designed with weep holes to allow water to drain out to the exterior of the structure, in adverse conditions the weep holes may become obstructed with debris thereby permitting the track to fill with water, seep under the sliding door and into the interior of the structure. In other scenarios, such as in a heavy storm, rainwater may be driven under the sliding glass door panel by forceful winds.

It is not always possible to design a structure where the sliding glass door is under a sufficient overhang to avoid rain and wind effects. In other situations, it is not convenient, nor advisable, to utilize known water diversion means, such as sandbags, since even a minor hole or tear in the sandbag could fill the track with sand-resulting in an undesirable mess within the track. Another detriment to using sandbags is that the sliding glass door can now no longer be opened from the inside without destroying the protection provided by the sandbags. Furthermore, in high-rise situations, where the sliding glass door leads to a closed balcony, it is impossible, or at best impractical, to sandbag the sliding glass door, and then get back into the dwelling.

It is also known in the art to use a wedge-like device to prevent flooding under sliding patio doors by blocking the space between a bottom of a sliding door panel and the top of the sliding door track, as is disclosed in commonly-owned U.S. Pat. No. 10,428,578 for “Device for preventing flooding in sliding patio doors.” However, this solution requires the use of a heavy material that is shapeable so that the weight of the device itself creates a sealing surface to the track and prevents the device from being blown away in strong winds.

Other proposed solutions in the art suffer from a “one-size-fits-most” design that proves to be ineffective in actual use and, furthermore, do not provide a comprehensive modular solution that addresses both water intrusion mitigation from outside, as well as, from the inside of the sliding glass door systems. The multitude and variety of sliding glass door types is multiplied by the vast number of installation scenarios. These types of doors typically have at least two doors (a sliding door and a stationary door), but more and more, multi-door and multi-panel installations are being used, with any number of moving and static door panels, thicknesses, and tracks. In different installation scenarios, and indeed in different door models, there exists a variety of installation types. For example, in some situations, the track is on or above the adjacent floor level and the track structure is therefore exposed above the floor surface. In other scenarios, the track is below the floor surface, creating an aesthetically pleasing “no-sill” installation. This presents other issues as now the track is below the surface of the inside floor and there is no protruding structure available for attachment of water intrusion mitigation devices. These “no-sill” installations can also either leave the track recessed, leaving a large opening, or in other scenarios, be covered by a track cover, which presents its own challenges since the track cover is not water-tight but now has reduced-sized gaps that still need to be attended to for water intrusion mitigation. The current proposed solutions in the art do not provide an adjustable or modular system that a user can adapt and configure, as needed, in order to create a tailor-made fit for their particular door system or installation scenario.

It would be advantageous, then, to have a device that provides the benefits of deflecting water from accumulating in the track of a sliding glass door, while also being lightweight and easy to use. It would also be advantageous to have such a device that also permits the sliding glass door to be opened and closed without having to go outside or remove the device. Additionally, it would be advantageous to have a device of this sort that further does not employ sandbags or similar heavy, yet pliable, means that could damage the smooth functioning of the track. Finally, it would be advantageous to have a windstorm rain and debris mitigation device, apparatus, and system that is modular and easy to configure for the most efficacy in any particular installation scenario providing a range of solutions for both outside and inside.

There is a need, therefore, for a lightweight, compact device that provides a physical barrier, which diverts water and wind away from the track of a sliding glass door during severe weather and that further provides a modular solution, addressing both outside and inside, for customized installations.

### SUMMARY OF THE INVENTION

We disclose a lightweight, compact, modular, and reusable device, and related system, that provides a physical barrier which diverts water and wind-driven debris away from the track of a sliding glass door—or equivalent structures—during severe weather conditions. The apparatus and related system disclosed includes a compact, reusable device, as well as a modular system, that reduces water intrusion during severe weather conditions and includes improvements to the apparatus and system disclosed in commonly owned and co-pending U.S. patent application Ser. Nos. 17/428,113 and 17/994,231.

In embodiments, we disclose a rain deflector apparatus that provides a water-resistant body surface adapted to reduce the intrusion of water into a sliding glass door track (or similar structure). The rain deflector is preferably, but not exclusively, installed by attaching it securely to the sliding glass door track and the deflector's innovative geometry and features maintains a sealing pressure against the floor or track, as well as the sliding door itself, thereby reducing the intrusion of water into a sliding glass door track (or similar structure) by diverting water and debris down and away from the door and track.

In a preferred embodiment, a rain deflector apparatus has a main body that is a substantially flat sheet having a front face, a back face, and a thickness defining a top edge, a bottom edge, a right edge, and a left edge. In embodiments, the thickness may vary from the top edge to the bottom edge. A bottom seal portion extends from the bottom edge, spanning substantially from the right edge to the left edge and, preferably, the entire length of the main body. A top sealing surface portion is disposed adjacent to the top edge, spanning substantially from the right edge to the left edge and, preferably, the entire length of the main body. Finally, a one or more attach mechanism is disposed in spaced relation on the back face between the top sealing surface portion and the bottom seal portion.

Further embodiments of the invention include one or more rain deflector apparatus incorporated as part of a system useful for the deflection of rainwater and storm debris from intrusion into a sliding glass door track or similar structure.

Yet further embodiments of the invention present the same principal structures of the preferred embodiment, namely a main body portion, a top sealing portion, a bottom sealing portion, and an attachment portion, as a combined system of one or more configurable structures assembled together as a modular system. In these embodiments, the invention presents a modular and configurable solution to the problem presented.

Other embodiments of a rain deflector system further include structures configured to provide additional rainwater intrusion mitigation when installed on the inside of the glass doors or similar structures.

Other embodiments of the invention include one or more of the structures, features, and components disclosed herein, assembled as a kit for customized and modular assembly by an end user, such as, but not limited to, a homeowner.

An object of the invention is to provide a practical and efficient way to reduce the amount of water intrusion through sliding glass doors during severe weather events in high-rise condominiums, townhouses, apartment buildings, and private residences by reducing the Bernoulli effect where there is large concentration of positive pressure that pushes water through weep holes and linear cavities that are created by the operable space between the door leaf and the door frame sill.

Another object of the invention is to provide a rain deflector apparatus that is easy to install and remove on a sliding glass door assembly or similar structure.

Another object of the invention is to provide a rain deflector apparatus that is sufficiently rigid so as to maintain its shape and rain deflecting characteristics, but also compliant enough so that it can be pressed up against adjacent installation surfaces and, when secured in place, provides a sealing force, pressing the rain deflector onto the adjacent installation surfaces.

Another object of the invention is to provide a rain deflector apparatus that is at least partially pliable, meaning compliant, so that a sliding glass door panel adjacent to which it is installed on its exterior, is able to be opened and closed without removing the rain deflector apparatus.

Another object of the invention is easy accessibility, meaning that, even after the exterior apparatus is installed in place, individuals can enter and exit through their sliding glass door as usual.

Yet another object of the invention is to provide one or more rain deflector apparatus as part of a system for deflecting rain from a sliding glass door, or similar structure.

Other features that are considered as characteristic of the invention are set forth in the drawings and preferred embodiment.

### Testing and Results:

Testing conducted and verified by independent engineers confirms that the present invention is “a unique solution designed to address the need for storm water mitigation. When installed per manufacturer specifications, this system offers robust protection against water infiltration through the tracks of sliding glass doors. By bolstering the resilience of these structures, the [ . . . ] system plays a crucial role in mitigating potential damage and financial losses due to severe weather events.”

These tests encompassed various severe weather scenarios, with a particular focus on assessing the efficacy of installing the inventive system in mitigating water intrusion compared to a controlled test with no system installed. The objective was to ascertain whether the use of the inventive apparatus and system significantly decreases water ingress under the influence of sustained wind pressures. The study's scope predominantly concentrated on evaluating the impact of positive wind pressure, seeking to provide valuable insights into the performance and potential benefits of this protective measure in enhancing the resilience of sliding doors in the face of extreme weather conditions.

The tests were conducted at a facility equipped with a twelve motor, 8400 hp fan bank, flow management, and water spray system, creating a 14′ high×20′ wide flow field capable of repeatable testing in up to 157 mph wind speeds. The controlled environmental conditions for these tests entailed the imposition of a precipitation rate of 4 inches per hour, coupled with wind speeds reaching 100-157 miles per hour for a duration of 5 minutes. During testing, it was established that the inventive system disclosed here eliminates a range of 95% to 99% of all water from entering through the tracks of sliding glass doors.

The results of the testing demonstrated that the inventive apparatus and related system is highly effective in reducing water intrusion and providing protection even in the most severe weather conditions.

Although the invention is illustrated and described herein as embodied in a device and related system for preventing the intrusion of wind-driven water and debris through a sliding glass door, the invention should not be limited to the details shown in those embodiments because various modifications and structural changes may be made without departing from the spirit and scope of the invention. Furthermore, while the invention is described within the context of a sliding glass door system, one of ordinary skill in the art will realize that the invention may be sized and configured as appropriate for other applications such as, but not limited to, windows, sliding doors without glass, and other similar structures.

The construction and method of operation and installation of the invention and additional objects and advantages of the invention are best understood from the following description of specific embodiments when read in connection with the accompanying drawings.

### BRIEF DESCRIPTION OF THE DRAWINGS

In the accompanying figures, like reference numerals refer to identical or functionally similar elements throughout the separate views. The accompanying figures, together with the detailed description below, are incorporated in and form part of the specification and serve to further illustrate various embodiments and to explain various principles and advantages all in accordance with the present invention, in which:

FIG. 1 shows an isometric back view according to an embodiment of the present invention;

FIG. 2 shows a side profile view of the invention shown in FIG. 1;

FIG. 3 shows a front view of the invention shown in FIG. 1;

FIG. 4 shows a back view of the invention shown in FIG. 1;

FIG. 5 shows a side profile view of the invention shown in FIG. 1, as installed in a simplified representative environment;

FIG. 6 shows a side profile view, according to an embodiment of the present invention;

FIG. 7 shows a side profile view, according to an embodiment of the present invention;

FIG. 8 shows a side profile view of a deflector apparatus according to an embodiment of the present invention;

FIG. 9 shows a back isometric view of the deflector apparatus of FIG. 8;

FIG. 10 shows a side profile view of a seal apparatus according to an embodiment of the present invention;

FIG. 11 shows a back isometric view of the seal apparatus of FIG. 10;

FIG. 12 shows a side profile view of a seal apparatus according to an embodiment of the present invention;

FIG. 13 shows a back isometric view of the seal apparatus of FIG. 12;

FIG. 14 shows a side profile view of a seal apparatus according to an embodiment of the present invention;

FIG. 15 shows a back isometric view of the seal apparatus of FIG. 14;

FIG. 16 shows a side profile view of an attachment apparatus according to an embodiment of the present invention;

FIG. 17 shows a top isometric view of the attachment apparatus of FIG. 16;

FIG. 18 shows a side profile view of an attachment apparatus according to an embodiment of the present invention;

FIG. 19 shows a top isometric view of the attachment apparatus of FIG. 18;

FIG. 20 shows a side profile view of an adapter according to an embodiment of the present invention;

FIG. 21 shows a top isometric view of the attachment apparatus of FIG. 20;

FIG. 22 shows a side isometric view of an end cap according to an embodiment of the present invention;

FIG. 23 shows a side view of a system according to an embodiment of the present invention, as installed in a simplified representative environment;

FIG. 24 shows a side profile view of a clamp according to an embodiment of the present invention;

FIG. 25 shows a bottom isometric view of the clamp of FIG. 24;

FIG. 26 shows a side profile view of a clamp according to an embodiment of the present invention;

FIG. 27 shows a bottom isometric view of the clamp of FIG. 26;

FIG. 28 shows a top isometric view of the inside components installed in a representative environment, according to an embodiment of the present invention;

FIG. 29 is a detailed view of FIG. 28;

FIG. 30 is a detailed view of FIG. 28;

FIG. 31 is a top isometric view of a clamp according to an embodiment of the present invention;

FIG. 32 is a top view of FIG. 31;

FIG. 33 is a top isometric view of a clamp according to an embodiment of the present invention;

FIG. 34 is a top view of FIG. 33;

FIG. 35 is an isometric exploded view of a Kit according to an embodiment of the present invention;

FIG. 36 is table illustrating the parts list corresponding to the Kit of FIG. 35;

FIG. 37 is a side profile view of a rain deflector utilizing an adaptor to join two deflector apparatus together, according to an embodiment of the present invention;

FIG. 38 is an isometric view of FIG. 37;

FIG. 39 is a profile view of an adaptor, according to an embodiment of the present invention;

FIG. 40 is an isometric view of FIG. 39;

FIG. 41 is a top isometric view of a system 4100 depicted as installed in a representative structure, according to an embodiment of the present invention;

FIG. 42 is a front view of FIG. 41;

FIG. 43 is a detail view of FIG. 42;

FIG. 44 is a partial cross-sectional view of FIG. 43;

FIG. 45 is a top isometric view of a clamp, according to an embodiment of the present invention;

FIG. 46 is a top isometric view of a system depicted as installed in a representative structure, according to an embodiment of the present invention;

FIG. 47 is a detail view of FIG. 46;

FIG. 48 is a top isometric view of a clamp, according to an embodiment of the present invention;

FIG. 49 is a side profile view of FIG. 48;

FIG. 50 is a front view of FIG. 48;

FIG. 51 is partial view representative of a system installation according to an embodiment of the present invention;

FIG. 52 is a top isometric view of a clamp, according to an embodiment of the present invention;

FIG. 53 is a side profile view of FIG. 52;

FIG. 54 is a front view of FIG. 52; and

FIG. 55 is partial view representative of a system installation according to an embodiment of the present invention.

While the invention as claimed can be modified into alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the scope of the present invention.

### DETAILED DESCRIPTION

Before describing in detail embodiments that are in accordance with the present invention, it should be observed that the embodiments have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

Though an embodiment may be disclosed as including several features, other embodiments of the invention may include fewer than all such features. Thus, for example, a claim may be directed to less than the entire set of features in a disclosed embodiment, and such claim would not include features beyond those features that the claim expressly recites.

The present disclosure is not a literal description of all embodiments of the invention. Also, the present disclosure is not a listing of features of the invention which must be present in all embodiments. Furthermore, various figures depict structures such as doors, glass, tracks, panels, sills, frames, and floors in order to show the invention in a representative installation environment and for context. These structures are depicted for reference only and, unless otherwise expressly claimed, form no part of the invention and are not intended to limit the scope of the claims in any way.

### Non-Limiting Definitions

The title of the present application and headings of sections provided in the present application are for convenience only, and are not to be taken as limiting the disclosure in any way.

In this specification and in the appended claims and drawings, words and phrases have the meanings commonly attributed to them in the relevant art except as otherwise specified herein. The terminology used herein is for the purpose of describing particular embodiments only and is not intended to be limiting of the disclosure.

The following non-limiting definitions are provided as a guide to interpreting the present invention:

The terms “a”, “an” and “the” mean “one or more”, unless expressly specified otherwise. As used herein, the singular forms “a”, “an” and “the” are intended to include the plural forms as well, unless the context clearly indicates otherwise.

The term “plurality” means “two or more”, unless expressly specified otherwise.

The term “herein” means “in the present application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel. The phrase “at least one of’, when such phrase modifies a plurality of things does not mean “one of” each of the plurality of things.

Numerical terms such as “one”, “two”, etc. . . . when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” describes both “based only on” and “based at least on”. The phrase “based at least on” is equivalent to the phrase “based at least in part on”.

The term “e.g.” and like terms mean “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

Any given numerical range shall include whole and fractions of numbers within the range. For example, the range “1 to 10” shall be interpreted to specifically include whole numbers between 1 and 10 (e.g., 1, 2, 3, 4, . . . 9) and non-whole numbers (e.g., 1.1, 1.2, . . . 1.9).

Where two or more terms or phrases are synonymous (e.g., because of an explicit statement that the terms or phrases are synonymous), instances of one such term/phrase does not mean instances of another such term/phrase must have a different meaning. For example, where a statement renders the meaning of “including” to be synonymous with “including but not limited to”, the mere usage of the phrase “including but not limited to” does not mean that the term “including” means something other than “including but not limited to”.

The terms “including”, “comprising” and variations thereof mean “including but not limited to”, unless expressly specified otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “product” means any machine, manufacture, and/or composition of matter, unless expressly specified otherwise.

The term “invention” and the like mean “the one or more inventions disclosed in this application”, unless expressly specified otherwise.

The terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The term “seal” means a part of the apparatus configured to prevent the traversal of a liquid (e.g. rainwater) or debris from one side of the seal to the other. The effectiveness of a seal is dependent on compression (in the case of, for example, bulb or blade seals) and adhesion (in the case of an adhesive seal). It is not here meant to require a perfect seal or an airtight seal or even a perfectly watertight seal.

The term “severe weather condition”, including grammatical equivalents, is used herein to describe an environmental event—either natural or man—made-whereby water (or other liquid), and possibly debris (as defined below), are driven by wind forces to accumulate and pass through a given barrier for a structure—here, a sliding glass door riding in a track, for example—into the interior of the structure, such intrusion causing damage to the interior of the structure. The term “severe weather condition” is not meant here to imply any particular meteorological category of severity—tropical storm, hurricane, etc. . . . —but merely describes, generally, an event of sufficient capability to cause unwanted water intrusion. While the invention described may indeed have some effectiveness with respect to rising or standing water (such as in a flooding or pooling condition), that is not within the scope of the term “severe weather condition”, or equivalents, as used herein.

The terms “rain” and “water” are meant here to include any wind-driven liquid. This could include, but is not limited to, water, seawater, pool water, and rainwater. While the invention described may indeed have some effectiveness with respect to rising or standing water (such as in a flooding or pooling condition), that is not within the scope of the terms “rain”, “water”, or equivalents, as used herein. The use of the term “rain”, “water”, or equivalents in a claim are for description and context and are not meant to limit the claim in any way.

The term “debris” means any solid, i.e. non-liquid, matter that is capable of clogging up the track, weep holes, or equivalent structure. The term “debris”, as used herein, is not meant to include large, wind-borne, matter that poses an adverse impact risk to the protected structure. For example, the invention disclosed here is not intended to provide impact resistance against large flying debris that could break or otherwise damage a sliding glass door, rather, it is typically encountered as dirt, sand, leaves, or other similar material that could accumulate in or around a track and clog the weep holes preventing proper drainage. As such, a person ordinarily skilled in the art would not consider shutters, impact panels, or other similar structures as being equivalent substitutes, or even in the same category or field of endeavor, as the present invention.

The term “extrusion” or “extruded” is used herein to describe a part, component, or feature that is principally described by a two-dimensional geometry that is projected into a third dimension along a given trajectory. For example, a cylinder may be here described as an extruded circle. This use of the term “extruded”, “extrusion”, or grammatical equivalents, is not meant in any way to limit the invention to a particular manufacturing method. An “extrusion” or “extruded profile” here may be, for example, machined, molded, cast, or forced through a die and cut to a length as in a traditional extrusion manufacturing method. Where a particular figure or drawing displays only the two-dimensional profile or cross-section, it is for compactness of disclosure only as the “extruded” view is readily known by the ordinarily skilled artisan. No limitation, disclaimer, or surrender of claim territory is intended through this economy of disclosure.

The term “adhesive”, and grammatical equivalents, is meant to include any attachment or fastening structure, whereby the attachment or fastening is accomplished by applying an initial compressive force, thereby “activating” the adhesive. The holding strength of the adhesive is to be selected based upon the desired installation application and can range from re-positionable to permanent. Included in the meaning of this term, “adhesive” includes hook and loop fasteners and equivalents as are known in the art. The adhesive may be a simple application of “glue”, or it may include a carrier, rigid or compressible foam, a pad, or other similar backing material.

The present invention may address one or more of the problems and deficiencies of the prior art discussed above. However, it is contemplated that the invention may prove useful in addressing other problems and deficiencies in a number of technical areas. Therefore, the claimed invention should not necessarily be construed as limited to addressing any of the particular problems or deficiencies discussed herein. While certain aspects of conventional technologies and methods in the relevant art have been discussed to facilitate disclosure of the invention, Applicant in no way disclaims these technical aspects or methods, and it is contemplated that the claimed invention may encompass one or more of the conventional technical aspects or methods discussed herein.

Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein. Specifically, component names, types, and values, as depicted in the exemplary schematic diagrams, are not intended to limit the scope of the present invention and are presented only as possible embodiments.

### Rain Deflector Apparatus 100

We disclose an inventive rain deflector that is an improvement over the prior art and adds novel features to the invention disclosed in commonly owned and co-pending U.S. patent application Ser. Nos. 17/428,113 and 17/994,231. The inventive rain deflector may be used singly, or in combination with multiple deflectors as needed to correspond to the number of panels in the sliding glass door, window, or other similar structure. Throughout this disclosure, we may also refer to the inventive rain deflector as a static deflector or a mobile deflector. This nomenclature corresponds with multi-panel sliding glass doors where, for example, one door slides (mobile) while the other door is stationary (static). In other sliding glass door systems, there may be multiple “mobile” doors and this disclosure contemplates all of those varied combinations and installation conditions.

The primary object of the current invention is to deflect, or prevent, as much water and debris as possible from accumulating in the track of the sliding glass door and, especially, in conditions with wind-driven rain, to mitigate the intrusion of water from being driven into the structure though any gaps between the sliding door and its track. This is accomplished via a combination of a physical barrier and a one or more seal. In embodiments, this seal may be achieved using a compression feature, such as a bulb seal, wiper seal, or compressible gasket material, or by using a bonding surface such as, but not limited to, an adhesive. In other embodiments, the seal is sufficiently achieved by virtue of the geometry and structural relationship between various components of the invention that, in conjunction, press structures together to form the seal.

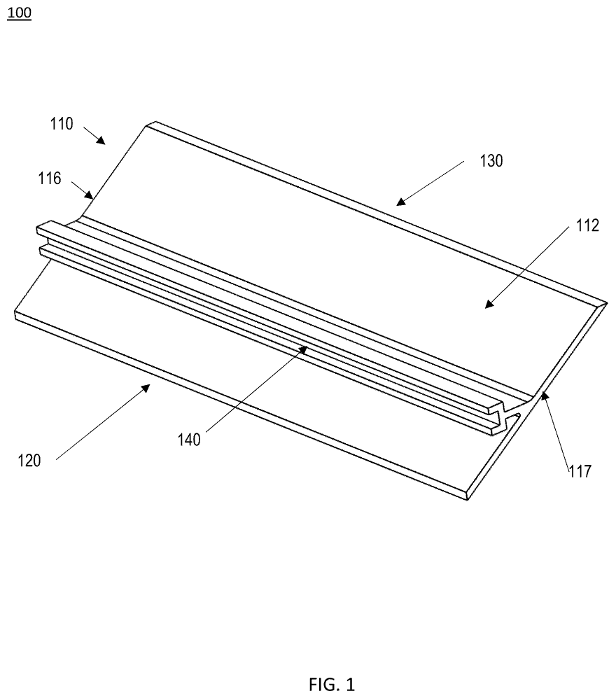

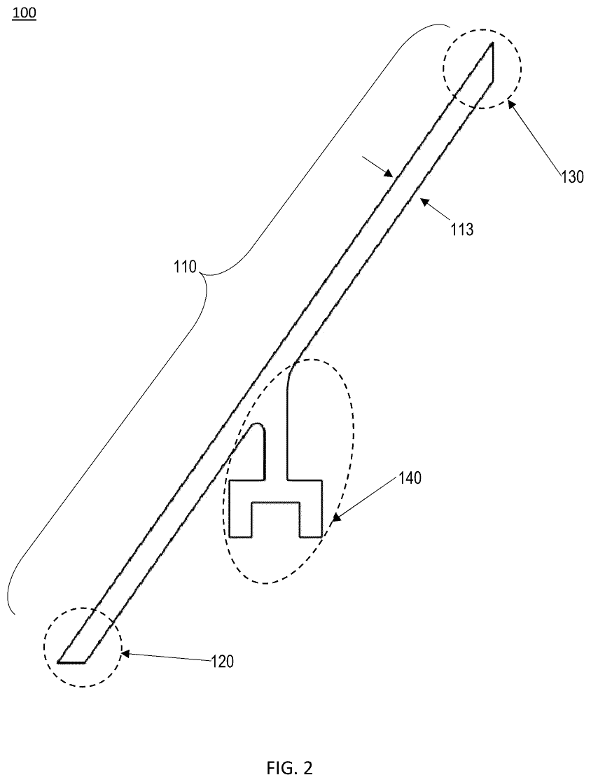

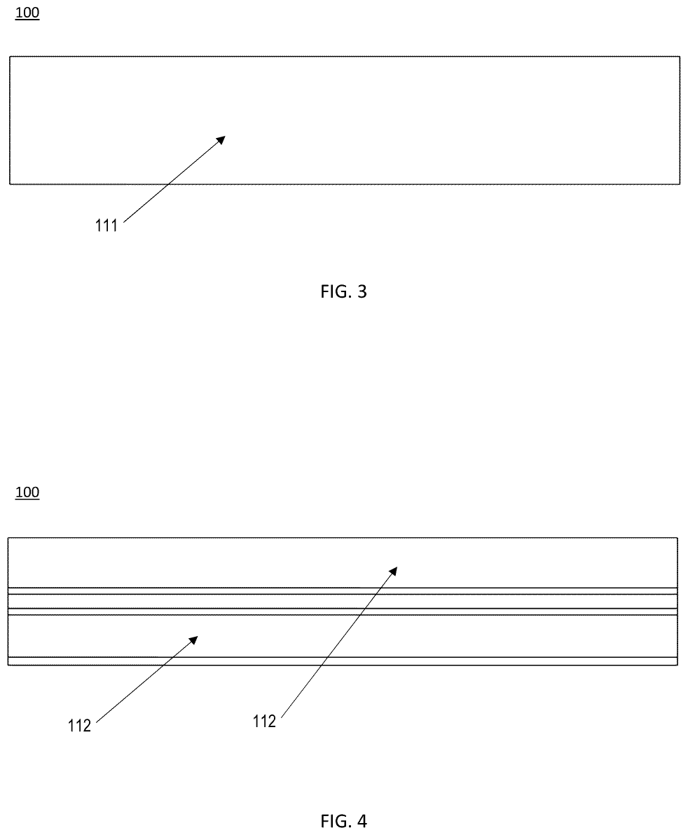

Referring now to the figures in general, and FIGS. 1-5, in particular, we disclose a preferred embodiment of a rain deflector apparatus 100, according to the invention. Rain deflector 100 is comprised of a main body 110, a first portion 120 that provides a seal along the bottom of the apparatus, a second portion 130 that provides a seal along the top of the apparatus, and a third portion 140 that provides an attachment mechanism by which the apparatus 100 is secured in relation to a sliding door track or similar structure.

The main body 110 has a front face 111, a back face 112, and a thickness 113 defining a top edge 114, a bottom edge 115 distal to the top edge 114, a right edge 116 substantially orthogonal to the top edge 114, a left edge 117 distal to the right edge 116, a front side 118 proximate to the front face 111, and a back side 119 proximate to the back face 112. The main body 110 provides the primary surface by which the apparatus 100 deflects and redirects rain, wind, and debris.

The first portion 120 of the main body 110 is proximate to the bottom edge 115 and is configured to create a first seal 121 against a first adjacent structure 1. In typical installations, the first adjacent structure 1 is the floor just outside of the sliding glass door track.

The second portion 130 of the main body 110 is proximate to the top edge 114 and is configured to create a second seal 131 against a second adjacent structure 2. In typical installations, the second adjacent structure 2 is the sliding glass door panel.

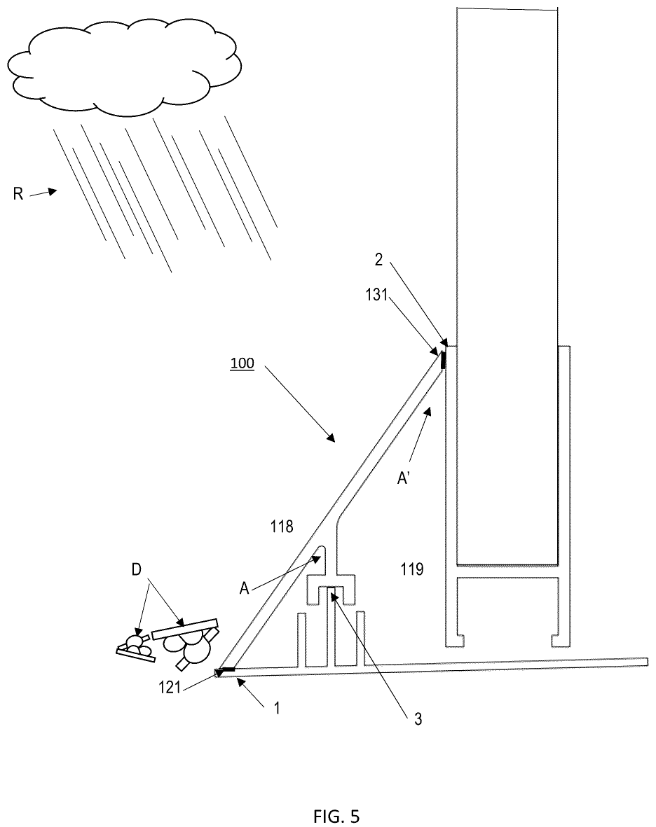

The third portion 140 of the main body 110 is proximate to the back face 112 and is configured to removably attach the apparatus 100 to a third adjacent structure 3 such that, when the apparatus 100 is attached to the third adjacent structure 3, said first seal 121 and second seal 131 are engaged thereby impeding a traversal of rain R and debris D from the front side 118 to the back side 119 (see FIG. 5). In typical installations, the third adjacent structure 3 is the track within which the sliding glass door panel sits.

The rain deflector 100 is preferably made of water- and weather-resistant material that can withstand the outdoor environments within which the invention is disclosed to operate. By way of example and not limitation, the rain deflector 100 can be made from Ethylene Propylene Diene Monomer (EPDM), Polyvinyl Chloride (PVC), santoprene, neoprene, silicone, TPE, PE, PP, or other suitable materials.

In further embodiments, the rain deflector 100 can be made of biodegradable, recyclable, repurposed, or disposable materials.

In embodiments, the material for the rain deflector 100 may present enough rigidity in height so as to not buckle under its own weight, but also offer a degree or flexibility along its length. In other embodiments, the relative rigidity or flexibility of the apparatus is achieved through the part's geometry or added component parts.

In embodiments, the rain deflector 100 is a unitary structure having the same material throughout.

In some other embodiments, the rain deflector 100 may be manufactured as a composite structure of different materials. Preferably, this would be accomplished along the division of one or more of the various functional structures discussed above: main body, top portion and seal, bottom portion and seal, and attach portion.

In yet other embodiments, one or more of the various functional structures of the rain deflector 100 may be manufactured as separate parts, or sub-assemblies, and assembled together to form the rain deflector 100.

Referring to FIG. 5, preferred embodiments of the rain deflector 100 are configured such that the third portion 140 protrudes from the back face at an angle A relative to the main body in order to orient the main body at an angle A′ relative to vertical, once installed, such that any rain R or debris D that falls on the front face will run down the front face away from the top edge.

Embodiments of the present invention include a seal feature or component, integral to the first portion, and that is chosen from the group consisting of a blade seal, a wiper seal, a flat compression seal (such as, but not limited to, a gasket), and an adhesive seal.

Embodiments of the present invention include a seal feature or component, integral to the second portion, and that is chosen from the group consisting of a blade seal, a wiper seal, a flat compression seal (such as, but not limited to, a gasket), and an adhesive seal.

Embodiments of the present invention include an attachment structure feature or component, integral to the third portion, and that is chosen from the group consisting of a clip, a clamp, and an adhesive.

In other embodiments, at least one of the first portion, the second portion, and the third portion is adapted to pivot in relation to the main body. This may be accomplished via a pivotably secure attachment between the separate components (as in the case where the rain deflector is composed of multiple separate components), or via a geometric or material configuration that allows for the pivoting of one portion relative to the other (as in the case of a unitary structure).

### Modular Rain Deflector System 200

As discussed above, in some embodiments, it is advantageous to manufacture one or more of the various functional features of the rain deflector as separate components, while still keeping within the scope of the present invention.

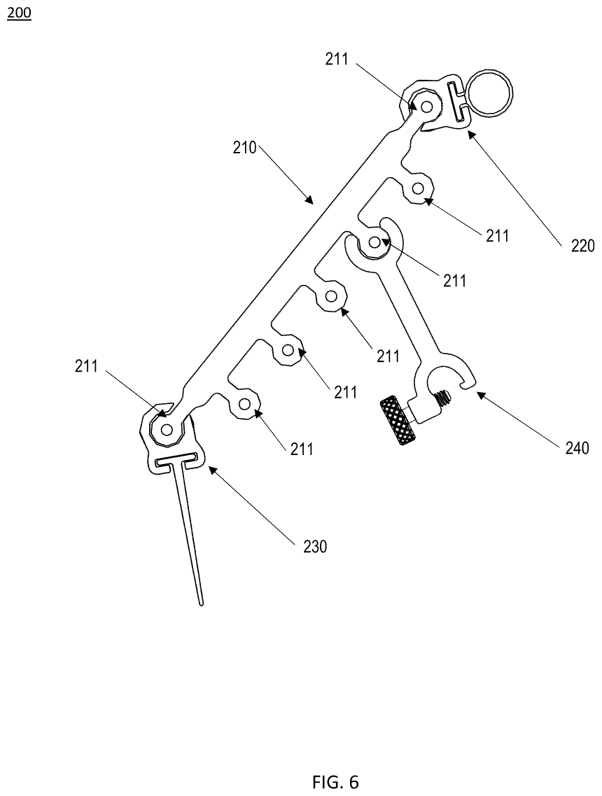

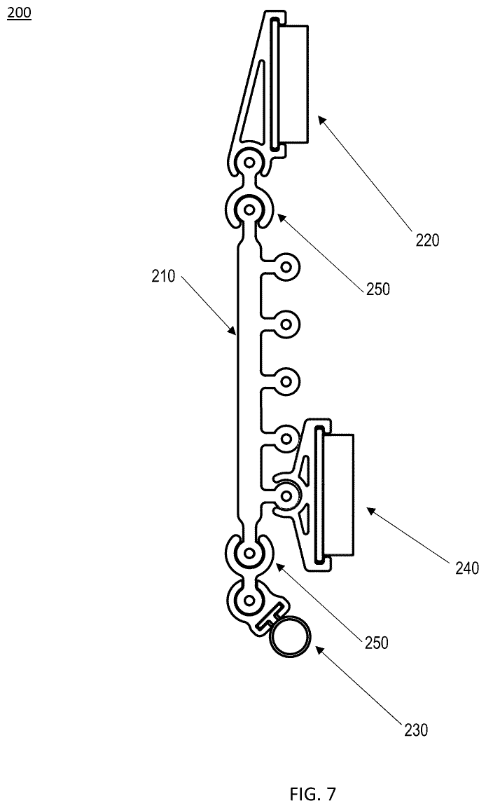

Referring now to FIGS. 6-22, we disclose example embodiments of such a modular rain deflector system 200 and example component parts and accessories. As illustrated in FIGS. 6 and 7, exemplary systems include a deflector apparatus 210, a top seal apparatus 220, a bottom seal apparatus 230, and one or more attachment apparatus 240.

The system components are configured with features that facilitate the secure assembly and connection of one component with the other. Preferably, and as shown in the figures, the components are securely attached during use, but may be easily detached from each other after use. For example, as shown in the embodiment depicted in FIGS. 6 and 7, the rain deflector 210 is configured with a plurality of protrusions 211, or “accessory rails”, having an offset cylindrical profile (substantially round). Each of these protrusions 211 is configured to mate in inserted relation with mating features on one or more additional component, such as, a top seal apparatus 220, bottom seal apparatus 230, and one or more attachment apparatus 240. In other embodiments, the protrusions 211 may be further configured to accept attachment of one or more adapter or other accessory as discussed herein.

In embodiments, the system 200 will always include at least one deflector apparatus 210 as the main component to which the other components are attached. In non-limiting embodiments, the deflector apparatus includes one or more accessory rails to which one or more component (or “accessory”) can be attached.

As discussed, relative to the rain deflector 100 embodiments, each of the top seal apparatus 220 and the bottom seal apparatus 230 may include different types of seal components as may be pertinent to the particular needs of an installation. These seal types may be, by way of example and not limitation, a bulb seal (as shown in top seal apparatus 220 of FIG. 6 and bottom seal apparatus 230 of FIG. 7), a blade seal (as shown in bottom seal apparatus 230 of FIG. 6), a compression (e.g. gasket) seal, or an adhesive seal (as shown in top seal apparatus 220 of FIG. 7).

Also, according to embodiments, attach mechanism 240 may be shorter in length than the rain deflector 210 (see FIGS. 17 and 19, for example). In this way, a plurality of attach mechanisms 240 may be assembled in inserted relation along the length of one or more protrusion 211 such that they may be slid along the protrusion 211 and positioned as may be most desired for ease and security of installation.

### Deflector Apparatus:

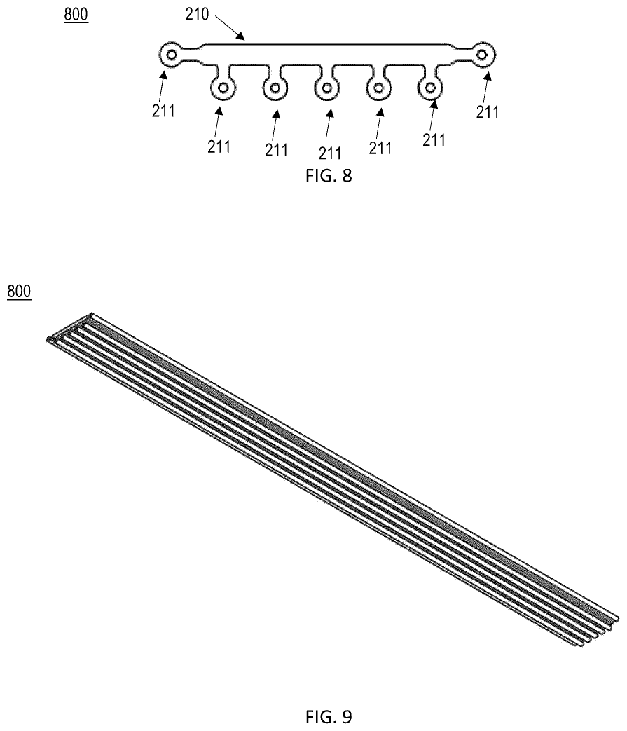

The deflector apparatus, as shown, generally in the various figures, is primarily a flat sheet structure—and herein correlated structurally with the main body of rain deflector 100. In embodiments, and as shown in FIGS. 8-9, a deflector apparatus 800 according to the invention has a main body 210 having a front face, a back face, and a thickness between the top face and the back face defining a top edge, a bottom edge distal to the top edge, a right edge substantially orthogonal to the top edge, a left edge distal to the right edge, a front side proximate to the front face, and a back side proximate to the back face (as shown and described relative to rain deflector 100).

A plurality of accessory rails 211 is shown in the exemplary embodiment of FIGS. 8 and 9. In the non-limiting embodiment shown, the cross-sectional profile of the accessory rail(s) is substantially cylindrical and configured to be mated in inserted relation to a mating component that includes a partial or substantially annular feature, having an interior diameter substantially similar to the outer diameter of the cylindrical cross-sectional profile. While a cylindrical profile provides certain mechanical advantages (such as allowing an attached component to pivot coaxially about it), it is contemplated to be within the scope of the invention for the cross-sectional profile of these accessory rails to be any shape that permits a component to be attached thereto.

Here, a top protrusion extends distally from the top edge and runs the length of the deflector apparatus, from the right edge to the left edge. This top protrusion has a cross-sectional profile that is configured to be assembled with a separate component.

Similarly, a bottom protrusion extending distally from the bottom edge and runs the length of the deflector apparatus, from the right edge to the left edge. This bottom protrusion has a cross-sectional profile that is configured to be assembled with a separate component.

Finally, a one or more back protrusion extends distally from the back face. This back protrusion runs the length of the deflector apparatus from the right edge to the left edge, in spaced relation between the top edge and the bottom edge. The one or more back protrusion also has a cross-sectional profile that is configured to be mated with a separate component.

While the particular embodiment shown and described herein depicts a deflector apparatus having all of the various protrusions with the same protrusion profile, it is thus for compactness of disclosure, and it is to be understood that any combination of one or more different protrusion profiles are contemplated to be within the scope and meaning of the present invention.

The deflector apparatus, then, is the backbone of the modular rain deflector system as the top, bottom, and back protrusions form accessory rails onto which multiple combinations of attachments may be assembled. Especially in the case of the back protrusions, since the rails run the length of the deflector, as will be discussed below, components that are shorter in length than the back protrusion(s) may be slid along the length of the rail in order to optimize the location and number of attachment mechanisms, or other components, used there. In this way the system is not only modular, but also adaptable to different installation conditions.

### Seal Apparatus:

Generally, a seal apparatus is disclosed that can be selectively utilized as a top seal apparatus or a bottom seal apparatus depending on which side of the deflector apparatus the seal apparatus is attached to. In this section, a “seal apparatus” and the various features and components thereof, may be interchangeably used as a “top” or “bottom” seal apparatus.

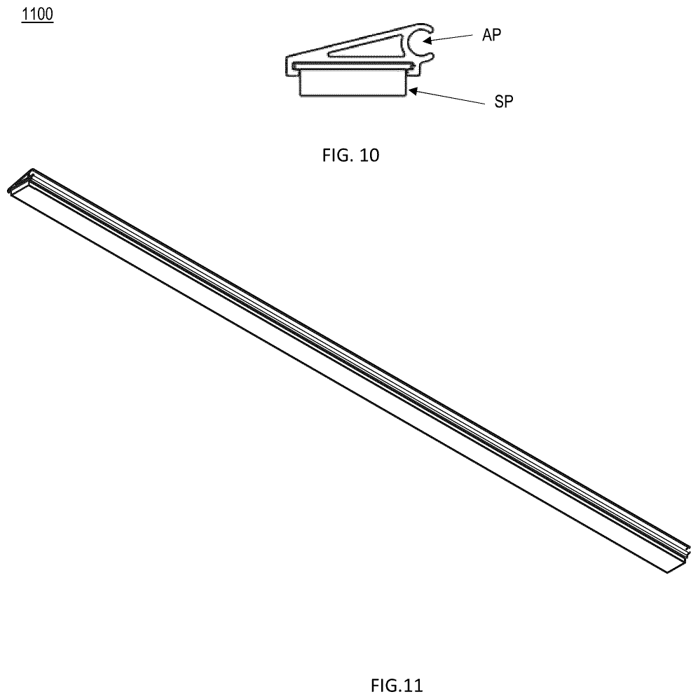

The seal apparatus includes a portion that is configured to attach the seal apparatus to the deflector apparatus and another portion that provides the “sealing” structure. Non-limiting examples of seal apparatus are shown in FIGS. 10-15. While it is contemplated that the seal apparatus may be manufactured as a single part, for purposes of modularity it may also be advantageous to manufacture the seal apparatus as an assembly of multiple parts and still be within the scope of the present invention. The length of the seal apparatus is preferably configured to be coextensive with the length of the deflector apparatus. In this way, a continuous sealing surface may be employed through the length of the deflector. However, in keeping with the modular and configurable aspects of this invention, the seal apparatus may be of a different length than the deflector—either longer or shorter—and still be within the scope of the invention. For example, it may be desirable in a particular installation to utilize multiple shorter seal apparatus components assembled in succession onto an accessory rail.

The seal apparatus includes an attachment portion AP and a seal portion SP.

FIGS. 10-11 depict a seal apparatus 1100 with an attachment portion AP and an adhesive seal SP. In embodiments, these figures also represent a seal apparatus having an attachment portion and a compression, or gasket, seal.

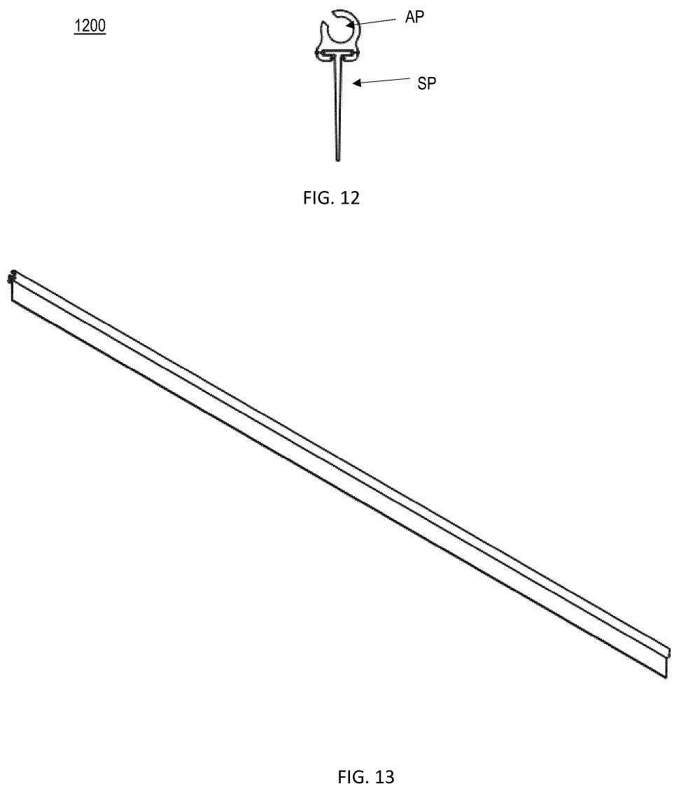

FIGS. 12-13 depict a seal apparatus 1200 with an attachment portion AP and a wiper, or blade, seal SP. In embodiments, the seal may include multiple “blades” of the same or varying length.

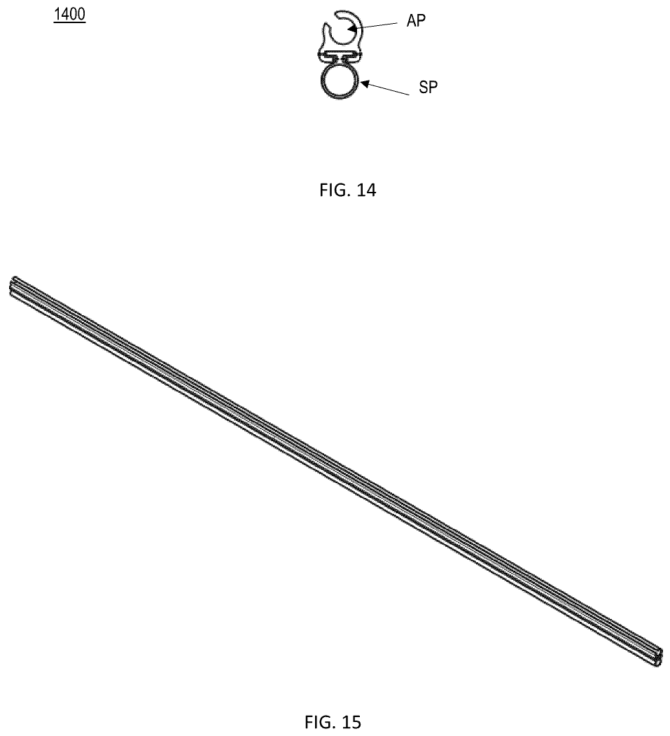

FIGS. 14-15 depict a seal apparatus 1400 with an attachment portion AP and a bulb seal SP. While the bulb seal depicted here is of a circular cross-section, other cross-sectional profiles are contemplated to be within the scope of the present invention.

### Attachment Apparatus:

As discussed with respect to rain deflector apparatus 100, the embodiments shown in FIGS. 6 and 7 include an attachment portion which is depicted as attachment apparatus 240. Attachment apparatus 240 includes a portion AP that is configured to attach onto one of the protrusions 211 of deflector apparatus 210. As opposed to the seal apparatus, the attachment apparatus is preferably attached to a protrusion 211 located on the back side of the deflector apparatus 210. Another portion of the attachment apparatus is a portion SA that is configured to securely attach to a track, door, frame, or other similar structure.

As discussed previously, the attachment apparatus may be a clamp, a clip, an adhesive—or a combination thereof.

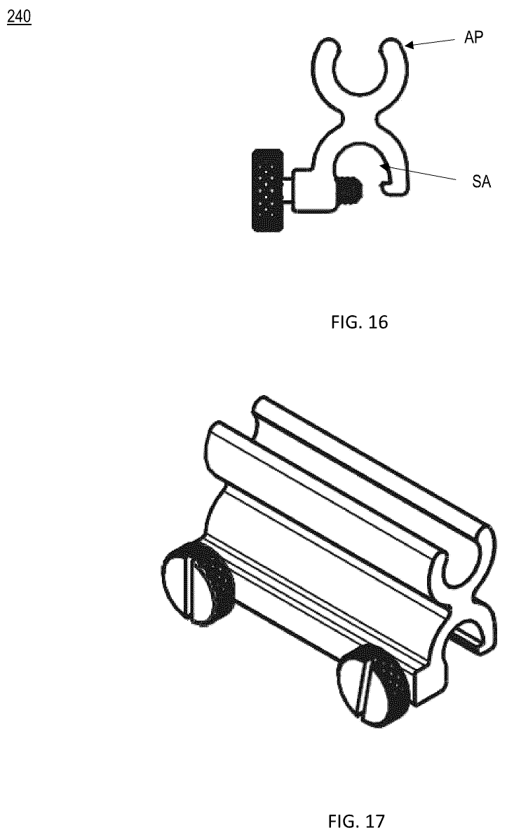

FIGS. 16-19 depict examples of attachment apparatus with a first portion AP that is configured to receive the protrusion 211 in inserted relation, and an attachment portion SA, distal from the first portion, configured to securely attach onto a track, door, glass, frame, or similar structure.

The example shown in FIGS. 16-17 depicts the use of a thumb screw, but other equivalent mechanism may also be employed as well as clips and clamping mechanisms as known in the art.

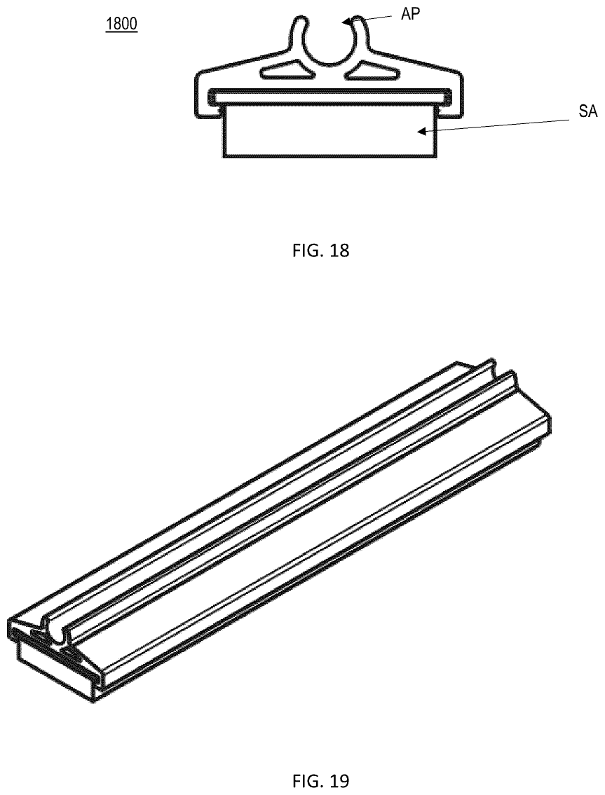

The example shown in FIGS. 18-19 depicts the use of an adhesive SA, but other equivalent bonding mechanisms (as described in the definitions section above) may also be employed.

Whereas it is preferably advantageous for the seal apparatus (top and/or bottom) to be of equal length with the deflector apparatus—thereby providing continuous sealing surfaces along the length of the rain deflector system—the attachment apparatus is preferably of a shorter length than the deflector apparatus (as illustrated in FIGS. 16-19). In this way, multiple attachment apparatus may be assembled onto the deflector apparatus and positioned along its length as required in order to facilitate easy and secure attachment to the installation structure (such as a sliding door track portion).

### Adapters:

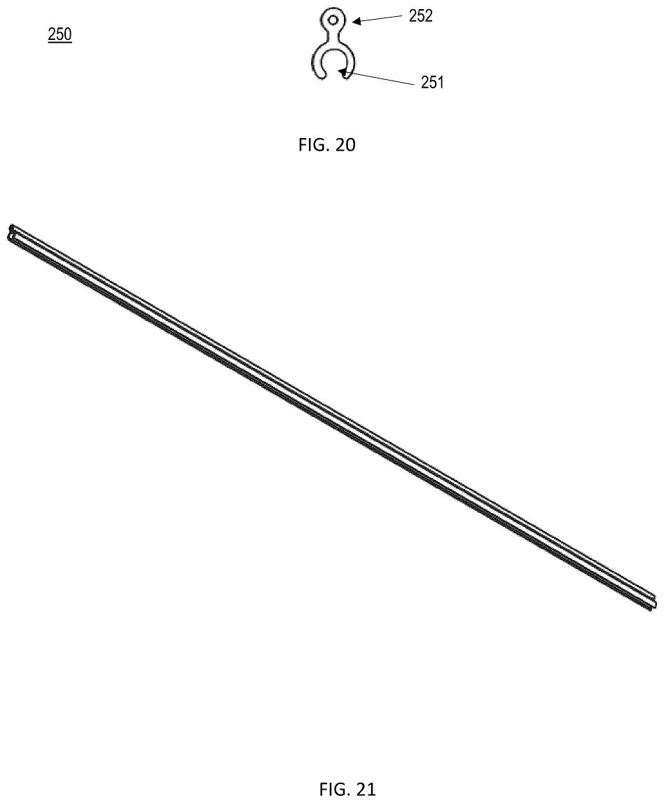

FIGS. 20-21 illustrate an exemplary adaptor 250. The adaptor has two ends distal from each other and separated by a length. One end 251 is configured to match the accessory rail profile of the deflector apparatus and the other end 252 is configured to match the attachment portion of the various components.

As illustrated in FIG. 7, embodiments of the present invention also include one or more such adapter 250 that is configured to attach between, for example, deflector apparatus 210 and a component, such as the top seal apparatus 220, thereby extending the length of the deflector apparatus and/or the angle of attachment of the attached component. Different lengths and/or angle of attachment may be achieved by employing different geometries and profiles for these adapters.

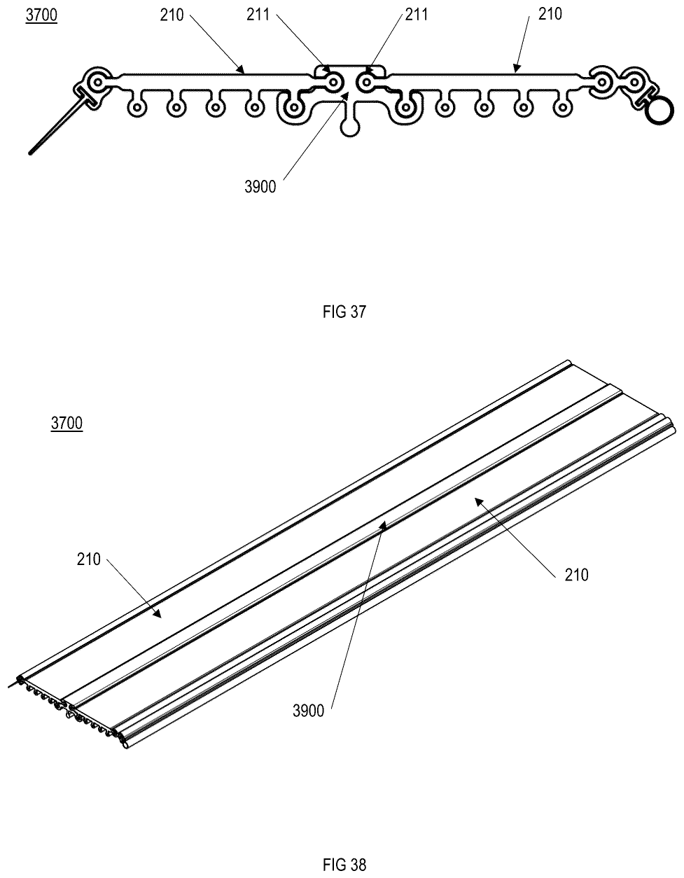

FIGS. 37-40 depict another type of adapter 3900 used to create multiple deflector system 3700. This adapter 3900 also has two ends distal from each other and separated by a length, however, this adapter is configured to link one deflector apparatus 210 to another deflector apparatus 210. The core features of this adapter 3900 are the central body 3910 and the two female receivers 3920. The female receivers 3920 are configured to accept deflector apparatus protrusion 211 in inserted relation.

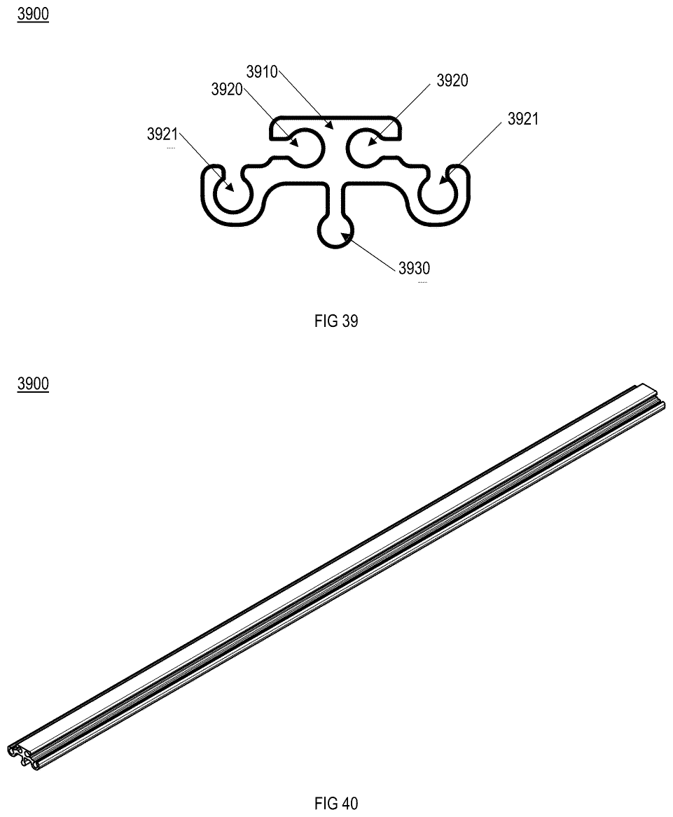

In embodiments, such as the one shown in FIG. 39, the adapter 3900 may also have one or more additional optional female receivers 3921, for example, to add rigidity between the components. Additionally, the adapter 3900 may further include one or more optional additional male protrusion 3930, which may be adapted to receive another attachment.

By using this type of adapter to link one deflector apparatus to another, the overall height of the whole system may be increased. Additionally, the additional height afforded by linking one, two, or more deflector apparatus permits for installations that have a wide track, thereby allowing for a greater horizontal distance between the top of the system and the bottom of the system.

### End Caps:

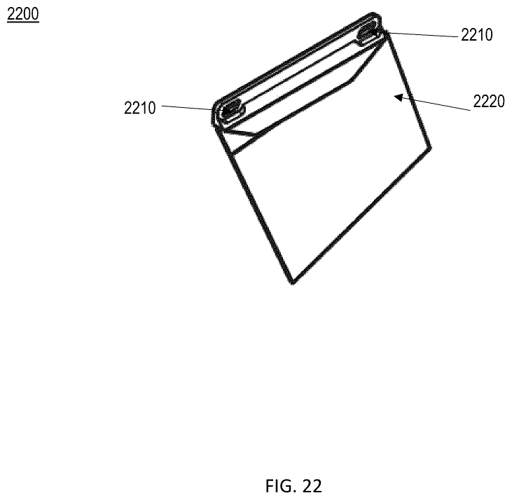

FIG. 22 depicts an exemplary end cap 2200 that attaches to the deflector apparatus by fastening onto, or into, the end of one or more accessory rail. The end cap has an attachment portion 2210 and a cap portion 2220, configured such that when assembled onto the deflector apparatus it provides a cover to the side of the apparatus between the apparatus and the door or similar structure.

### Multi-Panel System 1000 and Interior Water Mitigation Components:

As disclosed herein, as well as in the above-referenced parent applications, embodiments of the present invention include a system 1000 comprising multiple rain deflectors. For example, in an installation having a two-panel sliding glass door, one glass panel is static, and the other is mobile (in sliding relation to the static panel). A system 1000 according to the present invention comprises a one or more rain deflector apparatus 1010 (which may be of any embodiment disclosed herein, including but not limited to rain deflector apparatus 100, modular rain deflector system 200, or any combination of embodiments disclosed here or as incorporated by reference), each one rain deflector apparatus 1010 installed outside relative to each at least one static glass panel and each at least one mobile glass panel, whereby, the system is effective to substantially divert rain and debris from traversing from the outside to the inside of the sliding glass door panels.

Embodiments of the invention include interior water mitigation components. These various interior water mitigation components, as disclosed and discussed herein, function to mitigate the intrusion of water through the sliding glass door panels and tracks, as with the rain deflectors already discussed, however, while the rain deflectors are installed on the outside, these interior water mitigation components are configured to be preferably installed on the inside and have the primary object of mitigating the further intrusion of any water that may have passed the rain deflector. Although capable of being utilized on their own, a system including one or more rain deflectors installed on the outside, in combination with one or more interior rain mitigation components installed on the inside, provides a most complete water intrusion mitigation solution, according to embodiments of the invention.

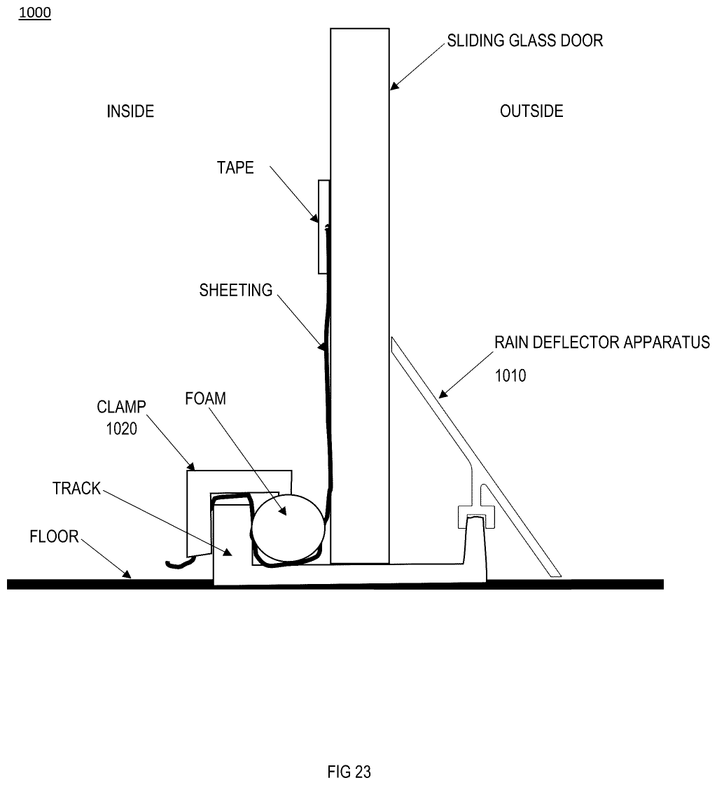

Referring now to FIG. 23, a simplified representation of the system 1000 is shown where the rain deflector 1010 is installed outside the sliding glass door and a one or more interior water mitigation component is installed inside the sliding glass doors. The one or more interior water mitigation components may be chosen from the group consisting essentially of: sheeting, tape, foam, adhesives, padded adhesives, and clamps.

In an exemplary embodiment, the system 1000 includes a rain deflector 1010 apparatus per each sliding glass door panel. The rain deflector 1010 is attached by securely attaching the rain deflector 1010 to a suitable structure on the outside of the corresponding sliding glass door panel. For example, if there is exposed track, the attach mechanism may be a clamp with a clip, thumb screw, adhesive, or other fixing mechanism such that the attach mechanism securely attaches to the track. If there is no track, or the track does not admit of a clip or clamp, the attach mechanism may be an adhesive, as discussed in the embodiments above.

Once secured, the rain deflector 1010 is pressed against the sliding glass door and the floor (or another surface) adjacent to the door. The “seal” interface at the top and bottom may be accomplished by any of the sealing mechanisms disclosed above.

On the inside, additional water mitigation components may be employed, singly or in combination. It will be understood that the following additional water mitigation components may be employed in systems utilizing one, or more than one, rain deflector. Although any one or combination of additional water mitigation components may be employed, in a most complete embodiment (illustrated in FIG. 23), the interior water mitigation components would include plastic (or similar) sheeting that would be taped to the glass and draped over the interior portion of the track. A length of compliant foam is pressed into the track, capturing the sheeting between the track and the foam, so as to seal the sheeting down into the track grooves. A one or more clamp 1020 is utilized to secure the foam and/or sheeting in the track.

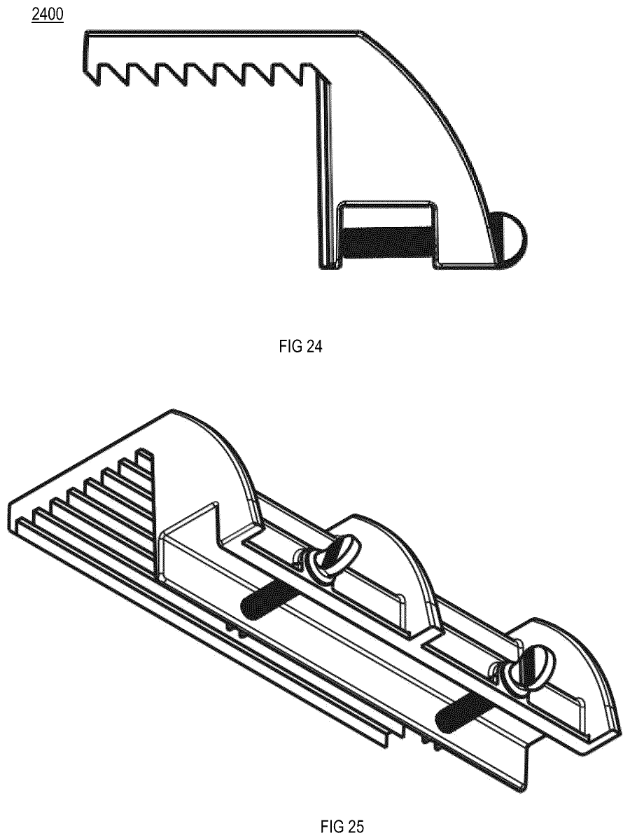

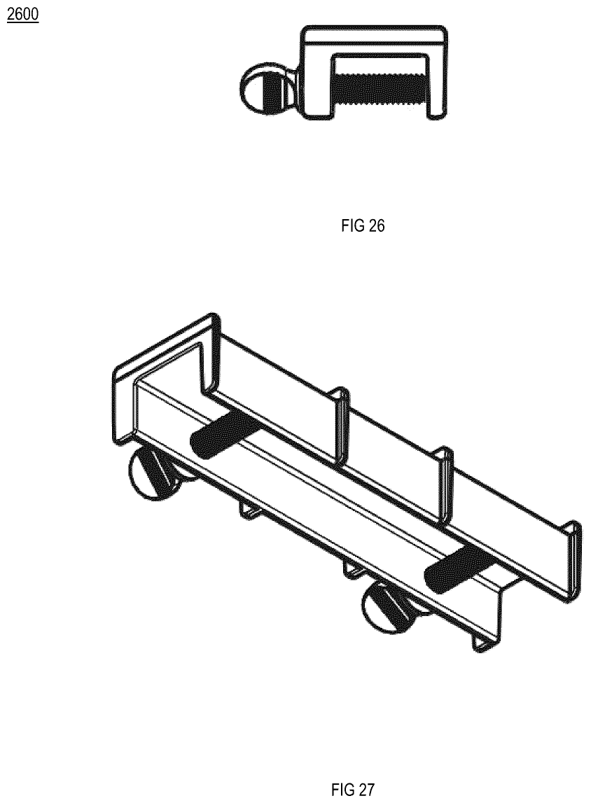

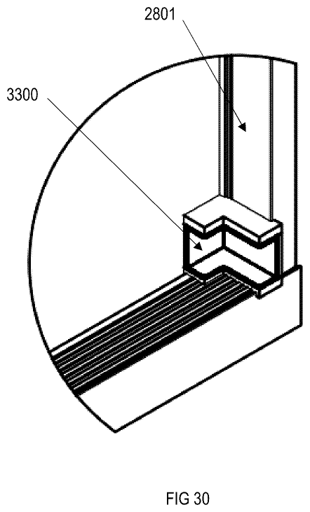

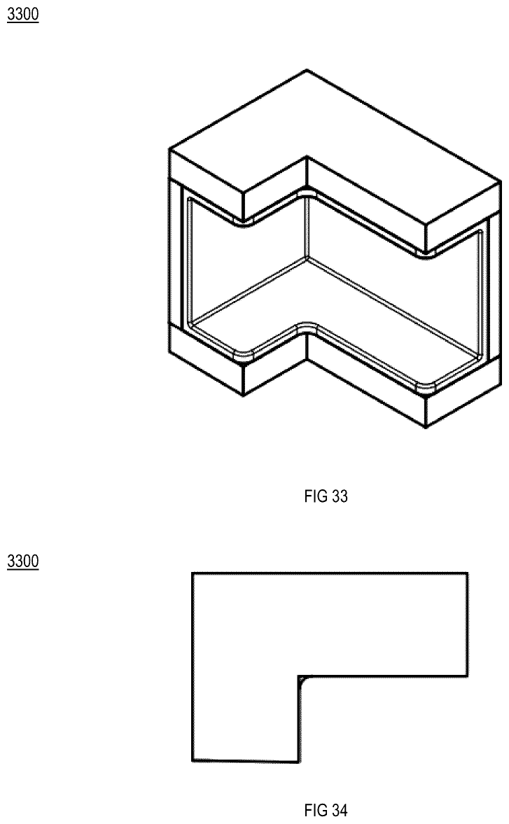

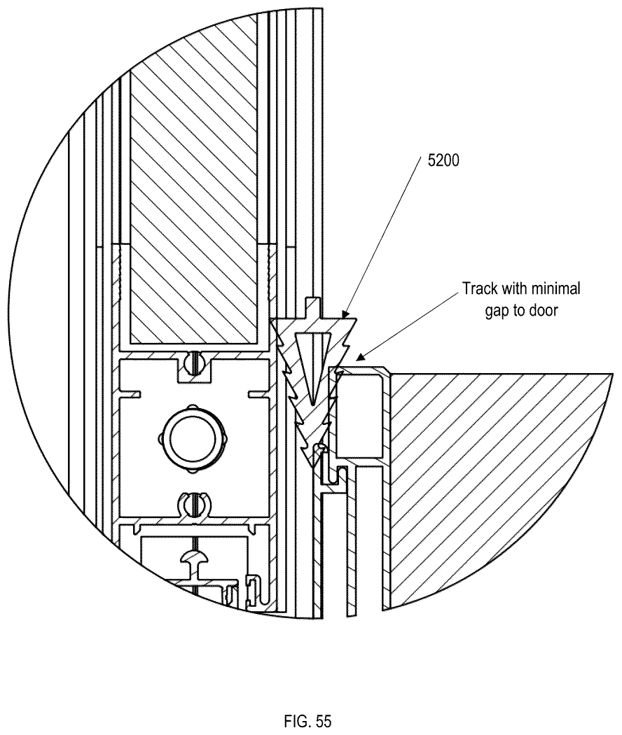

By way of example, and not limitation, exemplary clamps are depicted in FIGS. 24-34 and FIGS. 45-55.

The clamps 2400 and 2600 of FIGS. 24-27 include thumbscrews to attach the clamp to the track or similar structure while also holding down the foam and/or sheeting.

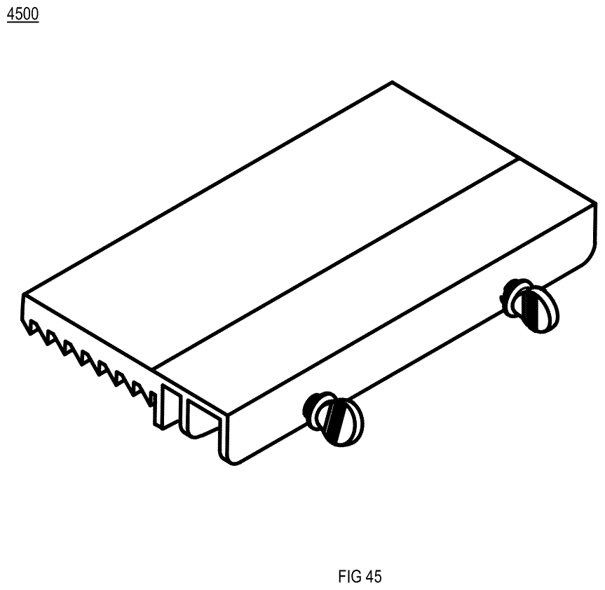

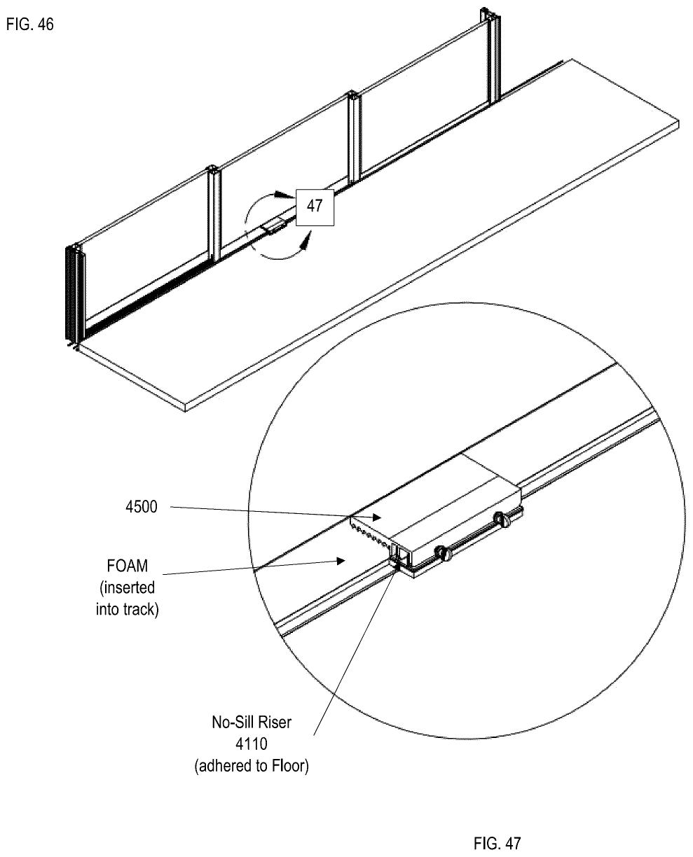

The clamp 4500 of FIG. 45 is a low-profile version of clamp 2400 and FIG. 46 illustrates clamp 4500 installed onto a no-sill riser 4110 and keeping a foam track filler in place.

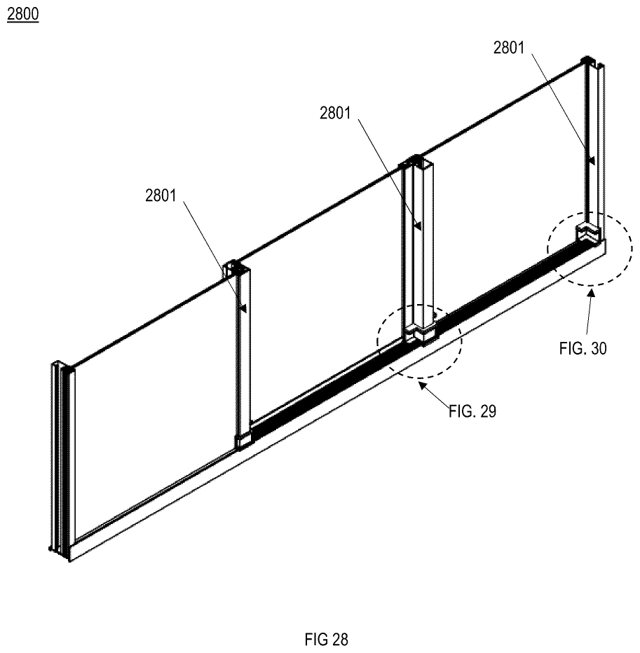

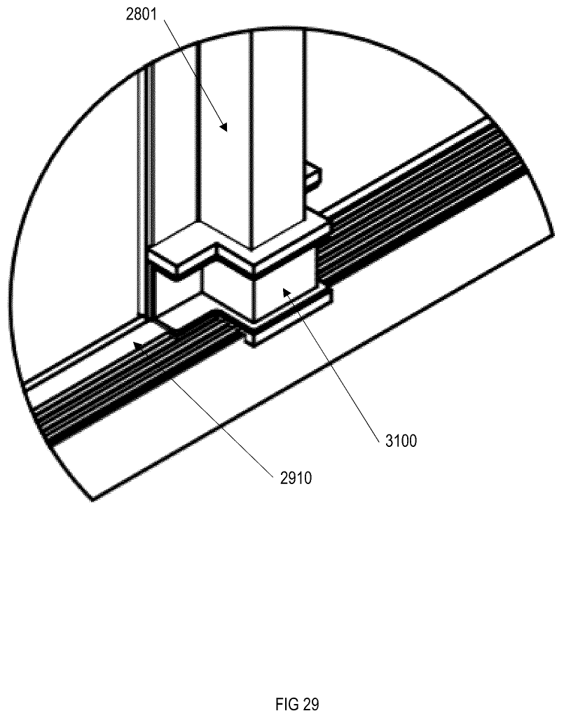

The clamps 3100 and 3300 shown in FIGS. 28-34 install up against the door stiles 2801 (vertical frame components) and include compliant foam on multiple surfaces in order to provide a compliant sealing surface. These types of clamps are beneficial in shallow or “no-sill” track installations and where foam cannot be inserted as described above. In these cases, the small gap between the door and the track may additionally be covered using a padded adhesive 2910 as shown in FIG. 29.

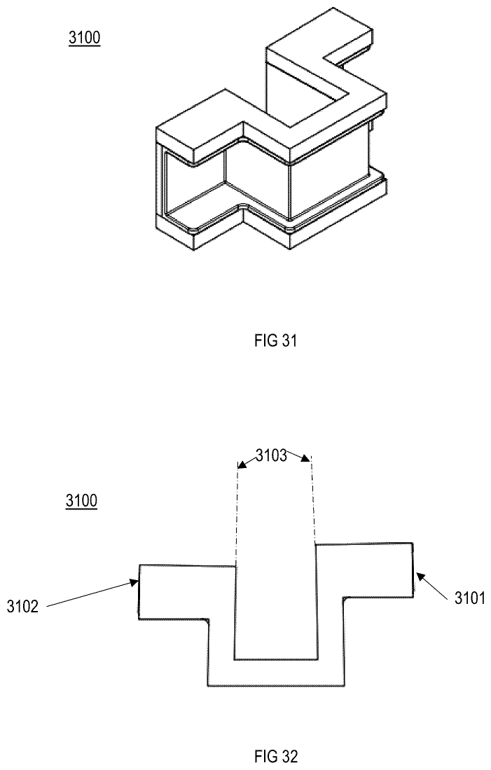

Additionally, the clamp 3100 depicted in FIGS. 31-32 include offset “legs” 3101 and 3102 in order to accommodate snug installation between doors sitting at two different planes. Also, the legs are canted towards each other (interior angle 3103) so as to provide a built-in clamping force for a snug fit onto a door stile.

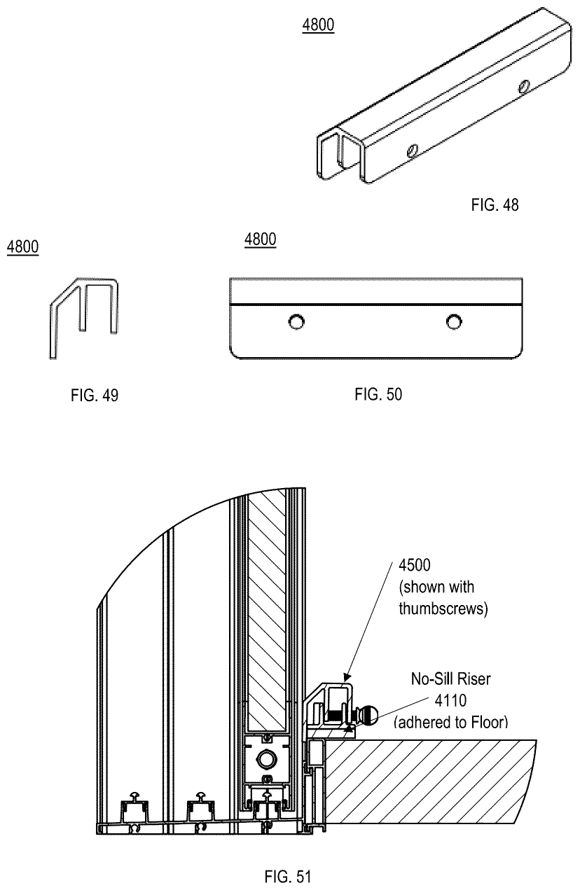

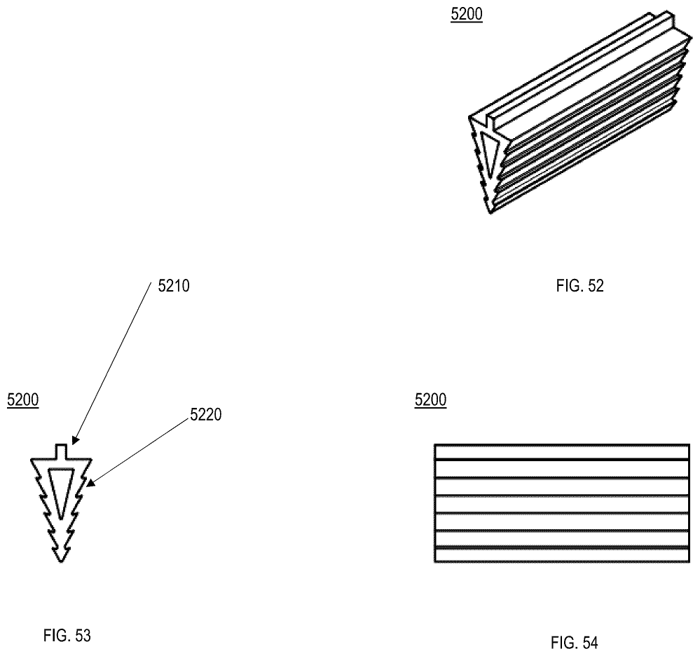

In other scenarios where there is a small gap between the door and floor, track, track cover, or other similar structure, or where there is a finished floor flush to the door track, embodiments of the invention include small-gap clamp 4800 (FIGS. 48-51) or gap-filler clamp 5200 (FIGS. 52-55). Gap-filler clamp 5200 includes a compliant or semi-compliant body 5210 that permits the clamp 5200 to be inserted under pressure into the small gap and a pull-tab 5210 to pull it back out for removal.

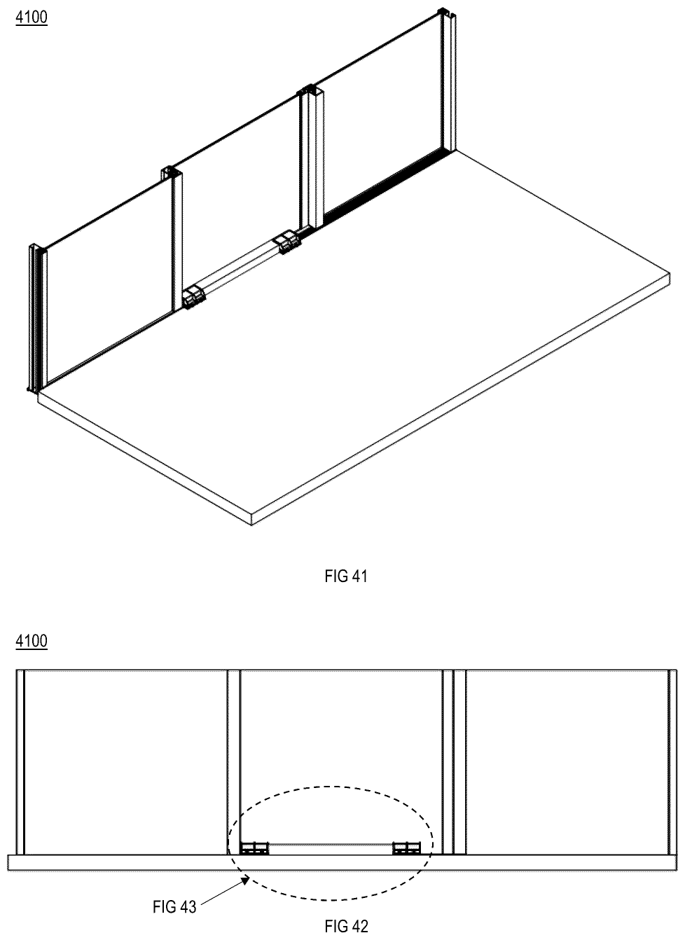

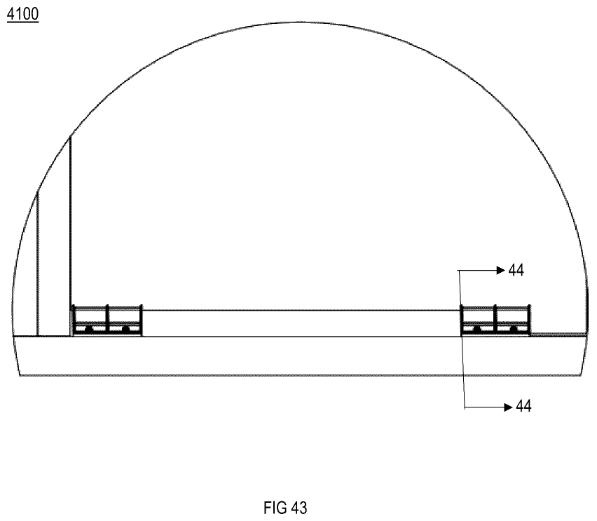

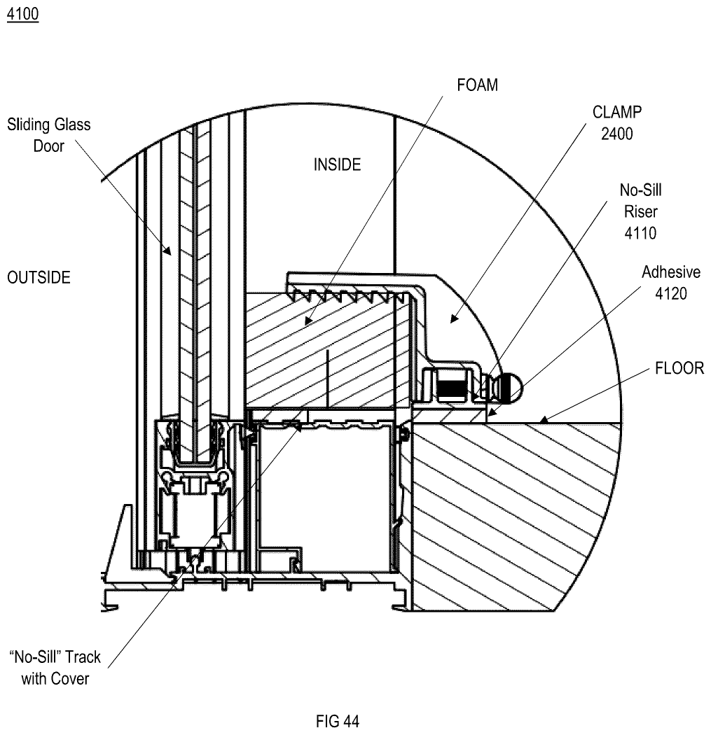

In another exemplary embodiment, system 4100 illustrates additional water mitigation components installed in a sliding glass door installation having no sill, a track cover, or otherwise without a way to insert foam into a track or any structure to attach a clamp onto. Referring now to FIGS. 41-44, and in particular FIG. 44, we discuss this type of installation scenario. FIG. 44 shows a cross-section of a type of sliding glass door where the track lies below the surface of the adjacent interior floor and has a track cover. As can be seen in this installation, there is no track structure for the foam to be pressed into. Additionally, there is no track or other structure for the clamp 2400 to be attached to. A no-sill riser 4110 component is utilized to provide an attachment structure for the clamp 2400 and is preferably secured in place using an adhesive 4120 to secure it onto the floor. With the no-sill riser 4110 securely in place, the foam can be placed to cover any remaining gaps between the sliding glass door, track, and track cover, and then pressed into place by securely attaching the clamp 2400 onto the no-sill riser 4110.

### Rain Intrusion Mitigation Kit:

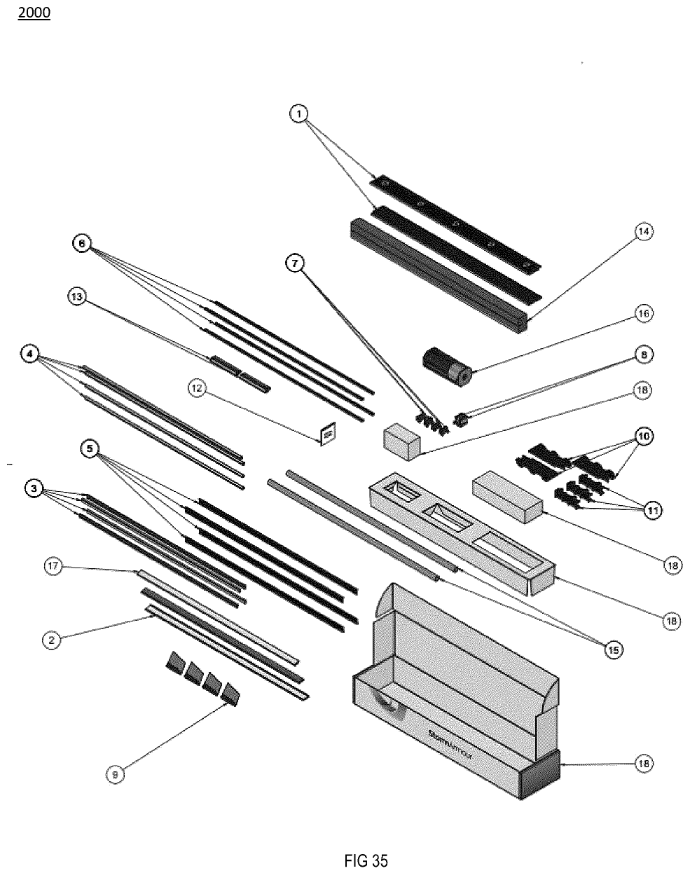

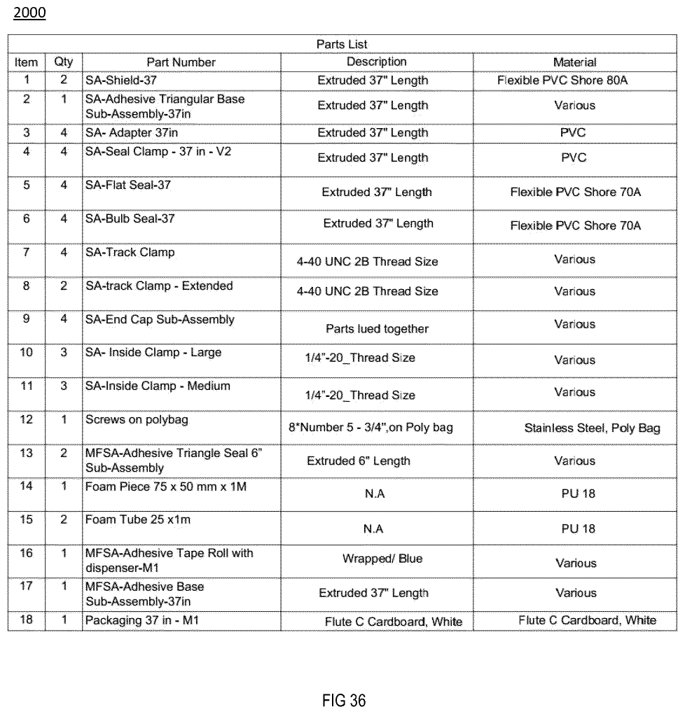

In embodiments, various components disclosed herein are combined into a kit for assembly and installation by a user. A non-limiting, exemplary, Kit 2000 is depicted in FIG. 35. A bill of materials (parts list) for exemplary Kit 2000 is shown in FIG. 36.

Kit 2000 provides various modular component parts for a user to assemble and install a complete rain intrusion mitigation system on a multi-panel sliding glass door (static and mobile doors), according to an embodiment of the present invention.

The Kit 2000 includes two rain deflectors and a plurality of clamps, seals, and adapters, as discussed above, that can be assembled onto the rain deflectors as may be most beneficial for the particular installation conditions.

Additionally, the Kit 2000 includes the various components discussed above for additional water intrusion mitigation on the inside of the sliding glass doors. These components include clamps, foam, adhesive, and sheeting. In the Kit 2000, as shown, “MFSA-Adhesive Tape Roll with Dispenser-M1”, item 16 (see FIG. 36), includes the sheeting with the adhesive pre-attached for ease of installation.

It is to be understood that Kit 2000 may be selectively populated with any of the parts, assemblies, and components disclosed herein in any quantity or configuration and still remain within the scope of the invention. The Kit 2000, depicted in the figures, is exemplary only and not intended to limit the Kit embodiment as to components or quantities.

The description of the present disclosure has been presented for purposes of illustration and description, but is not intended to be exhaustive or limited to the invention in the form disclosed. Many modifications and variations will be apparent to those of ordinary skill in the art without departing from the scope and spirit of the disclosure. In particular, features from one embodiment can be used with another embodiment. The embodiments were chosen and described to best explain the principles of the disclosure and the practical application, and to enable others of ordinary skill in the art to understand the invention for various embodiments with various modifications as are suited to the particular use contemplated.

1. A rain deflector apparatus comprising:
a main body having a front face, a back face, and a thickness defining a top edge, a bottom edge distal to the top edge, a right edge extending from the top edge to the bottom edge, a left edge distal to the right edge;
a first portion of the main body, proximate to the bottom edge, configured to create a first seal against a first adjacent structure;
a second portion of the main body, proximate to the top edge, configured to create a second seal against a second adjacent structure; and
a third portion of the main body, proximate to the back face, configured to removably attach the apparatus to a third adjacent structure such that, when the apparatus is attached to the third adjacent structure, said first seal and second seal are engaged thereby impeding a traversal of rain.

2. The rain deflector apparatus of claim 1 where the third portion of the main body is further configured to orient the main body at an angle relative to vertical such that any rain that falls on the front face will run down the front face away from the top edge.

3. The rain deflector apparatus of claim 1 where the apparatus is a unitary structure.

4. The rain deflector apparatus of claim 1 where at least one of the first portion, the second portion, and the third portion is a separate component that is configured to be attached to the main body.

5. The rain deflector apparatus of claim 1 where the first portion includes a seal chosen from the group consisting of a blade seal, a wiper seal, a bulb seal, a compression seal, and an adhesive seal.

6. The rain deflector apparatus of claim 1 where the second portion includes a seal chosen from the group consisting of a blade seal, a wiper seal, a bulb seal, a compression seal, and an adhesive seal.

7. The rain deflector apparatus of claim 1 where the third portion includes an attachment structure chosen from the group consisting of a clip, a clamp, and an adhesive.

8. The rain deflector apparatus of claim 1 where at least one of the first portion, the second portion, and the third portion is adapted to pivot in relation to the main body.

9. The rain deflector apparatus of claim 1 where the main body is further configured with one or more protrusions adapted to receive one or more attachments.

10. A modular rain deflector system, the system comprising;
a deflector apparatus having a main body and a plurality of attachment protrusions disposed thereon;
a top seal apparatus configured to attach to one of the attachment protrusions;
a bottom seal apparatus configured to attach to one of the attachment protrusions; and
a one or more attachment apparatus configured to attach to one or more of the attachment protrusions,
whereby the modular rain deflector system is sealably attachable to a structure thereby reducing water intrusion therein.

11. The modular rain deflector system of claim 10 further comprising one or more adapter configured to attach between the deflector apparatus and one of either the top seal apparatus, the bottom seal apparatus, one of the one or more attachment apparatus, another adapter, or another deflector apparatus.

12. The modular rain deflector system of claim 10 further comprising a one or more end cap attached to an end of the deflector apparatus.

13. The modular rain deflector system of claim 10 where the top seal apparatus further comprises a top attachment portion and a top seal portion.

14. The modular rain deflector system of claim 13 where the top seal portion is chosen from the group consisting essentially of a bulb seal, a wiper seal, a blade seal, and an adhesive seal.

15. The modular rain deflector system of claim 10 where the bottom seal apparatus further comprises a bottom attachment portion and a bottom seal portion.

16. The modular rain deflector system of claim 15 where the bottom seal portion is chosen from the group consisting essentially of a bulb seal, a wiper seal, a blade seal, and an adhesive seal.

17. The modular rain deflector system of claim 10 where each of the one or more attachment apparatus further comprises a deflector attachment portion and a track attachment portion.

18. The modular rain deflector system of claim 17 where the track attachment portion is chosen from the group consisting essentially of a clip, a clamp, and an adhesive.

19. The modular rain deflector system of claim 10 where each of the one or more attachment apparatus is slidingly attached to the rain defector apparatus.

20. A system for diverting rain from sliding glass panels having at least one static glass panel and at least one mobile glass panel riding within a track and defining an inside and an outside, the system comprising:
a one or more rain deflector apparatus, each one rain deflector apparatus installed outside relative to each at least one static glass panel and each at least one mobile glass panel, each one of the rain deflector apparatus comprising:
a main body having a front face, a back face, and a thickness defining a top edge, a bottom edge distal to the top edge, a right edge extending from the top edge to the bottom edge, a left edge distal to the right edge;
a first portion of the main body, proximate to the bottom edge, configured to create a first seal against a first adjacent structure;
a second portion of the main body, proximate to the top edge, configured to create a second seal against a second adjacent structure; and
a third portion of the main body, proximate to the back face, configured to removably attach the apparatus to a third adjacent structure such that, when the apparatus is attached to the third adjacent structure, said first seal and second seal are engaged thereby impeding a traversal of rain,
whereby, the system is effective to substantially divert rain from traversing from the outside to the inside of the sliding glass door panels.

21. The system of claim 20 further comprising a compliant foam barrier configured to be disposed within the track on the inside of the sliding glass panels.

22. The system of claim 20 further comprising a sheeting disposed on the inside of the sliding glass panels, constrained between the compliant foam barrier and the track.

23. The system of claim 20 further comprising a one or more clamp configured to constrain the compliant foam barrier substantially within the track.

24. The system of claim 20 further comprising a one or more clamp configured to attach to a door stile proximate to the track thereby providing a seal around the door stile.

25. The system of claim 20 further comprising a padded adhesive configured to span small gaps on the inside portion of the sliding glass door.

26. The system of claim 20 further comprising a no-sill riser.

27. A Kit for diverting rain from sliding glass panels having at least one static glass panel and at least one mobile glass panel riding within a track and defining an inside and an outside, the Kit, installable and configurable by a user, comprising:
a one or more rain deflector apparatus;
a plurality of attachment apparatus; and
a plurality of seal apparatus.

28. The Kit of claim 27 further comprising at least one or more of the following: adapters, end caps, foam, clamps, tape, no-sill risers, flat adhesives, padded adhesives, and sheeting.
